(19) United States
(12) Patent Application Publication
(10) Pub. No.: US 2024/0387957 A1
(43) Pub. Date: Nov. 21, 2024

(54) CONNECTION PART FOR AN ELECTROCHEMICAL CELL HAVING A PRISMATIC SHAPE

(71) Applicant: SAFT, Levallois-Perret (FR)

(72) Inventor: Gérard RIGOBERT, FARGUES St HILAIR (FR)

(73) Assignee: SAFT, Levallois-Perret (FR)

(21) Appl. No.: 18/688,483

(22) PCT Filed: Jul. 27, 2022
(86) PCT No.: PCT/EP2022/071059

§ 371 Date: Mar. 1, 2024

(30) Foreign Application Priority Data
Sep. 3, 2021 (FR) FR2109227

(51) Int. Cl. H01M 50/533; H01M 10/04; H01M 10/0525; H01M 50/103; H01M 50/15; H01M 50/536

(52) U.S. Cl. CPC H01M 50/533; H01M 10/049; H01M 10/0525; H01M 50/103; H01M 50/15; H01M 50/536

(57) ABSTRACT

An electrochemical cell includes a container having a bottom and containing an assembly of parallelepipedal plates consisting of one or more positive plates including positive tabs and negative plates including negative tabs, separated by a separator; one or more covers closing an opening of the container; an electrical connection part of a given polarity connecting a tab of the same polarity to a current output terminal of the cell of the same polarity, fixed to a cover; an electrical connection part of opposite polarity connecting a tab of opposite polarity to a current output terminal of opposite polarity, which is fixed to, and electrically insulated from, the cover, the bottom of the container, or a second cover electrically insulated from the first cover; the connection parts each comprising a support plate having a projecting element for connecting a given polarity tab to the current output terminal of corresponding polarity.

### FIELD OF THE INVENTION

The field is that of electrochemical cells of prismatic format and more precisely that of the electrical connection parts used to connect the electrodes of an electrochemical cell of prismatic format to the current collecting terminals of the cell.

### BACKGROUND OF THE INVENTION

Electrochemical cells of parallelepiped format or prismatic format are commonly manufactured. In such a format, the electrodes can be in the form of flat plates. An electrode plate group, or bundle of plates, is made up of an alternation of positive plates and negative plates. Each positive or negative plate is made up of a metal strip serving as a current collector. A layer of a positive or negative active material composition is deposited on one or both faces of the metal strip. A separator is inserted between a positive plate and a negative plate. All of the positive plates are electrically connected to a positive current collecting terminal. Likewise, all of the negative plates are electrically connected to a negative current collecting terminal. The positive and negative terminals are typically located on the cell cover.

The tab is the part of the metal strip which is not covered with a layer of active material composition. This bare part, generally square or rectangular, is located on one of the edges of the plate. FIG. 1 schematically shows an electrode plate group, F, of parallelepiped format formed by the assembly of a rectangular positive plate (+), a separator S and a negative rectangular plate (−). A positive tab 1 and a negative tab 2 protrude from the upper edge of the electrode plate group. The positive tab 1 is characterized by a height h1 and a width 11. The negative tab 2 is characterized by a height h2 and a width 12. The dimensions of the positive tab may be the same or different from those of the negative tab. In FIG. 1 only one positive plate, one separator and one negative plate are shown, but this alternation can be repeated to obtain an electrode plate group comprising a plurality of positive plates and a plurality of negative plates, each positive plate being separated from a negative plate by a separator. The position of the tab on a positive plate is the same for all positive plates in the electrode plate group. Likewise, the position of the tab on a negative plate is the same for all negative plates in the electrode plate group. Thus, after super-positioning the plates to form the electrode plate group, the tabs of the same polarity overlay each other.

In FIG. 1, the positive and negative tabs are located on the same edge of the electrode plate group. However, they can also be located on two different edges.

The electrical connection of all the positive, respectively negative, plates to the positive, respectively negative, current collecting terminal is carried out by using an electrical connection part which is in the form of a metal strip. One of the ends of this strip is welded to all the tabs of a given polarity while the opposite end of the strip is welded to a current collecting terminal. That is, a positive electrical connection part connects the tabs of all positive plates to the positive current collecting terminal. Similarly, a negative electrical connection part connects the tabs of all negative plates to the negative current collecting terminal.

To prepare the step of welding the tabs of a given polarity to one of the ends of the metal strip, it is customary to bend the tabs so as to bring the flat surface of the tabs into abutment with the surface of the metal strip and thus obtain two flat surfaces against each other. Such an arrangement is shown in FIG. 2. This shows a sectional view of two electrode plate groups F-1, F-2 arranged one against the other. The tabs of a given polarity 1 or 2 protrude from the upper edge of the two electrode plate groups. Their end is bent over to form a horizontal base. The horizontal base is connected by welding to a common electrical connection part 3 which is an L-shaped metal strip. FIG. 3 is a perspective view of two electrode plate groups arranged against each other. The tabs of the positive plates 1 are intended to be connected to a positive electrical connection part 3-1. The tabs of the negative plates 2 are intended to be connected to a negative electrical connection part 3-2.

The free end of the positive and negative electrical connection parts is then connected to the feet at the bottoms of the positive or negative current collecting terminals which are generally located on the face of the cover intended to be oriented towards the inside the cell, once it is closed. FIG. 4 is a perspective view of the upper part of the two electrode plate groups after welding the free end of the positive and negative electrical connection parts 3-1, 3-2 to the feet of the positive and negative current collecting terminals 4-1, 4-2 located under the cover 6 of the cell 15. FIG. 5 is a sectional view of the two electrode plate groups F-1, F-2 after welding the free end of one of the two electrical connection parts on the foot 4-1 of the current collecting terminal 5 of the same polarity, located under the cover 6 of the cell 15.

The electrode plate groups are then introduced into a container.

Starting from the situation illustrated in FIG. 5, the branch of the “L” of the electrical connection part 3-1 which is welded to the current collecting terminal is angled at approximately 90° to bring the edges of the cover in contact with the edges of the container and close the cell.

In the prior art method, which has just been described, a significant portion of the internal volume of the cell is occupied by the tabs 1, 2 folded on themselves. FIGS. 2 and 5 show that these take on a “V” shape. The spacing between the two branches of the “V” can reach 7 to 8 mm for tabs with a height h generally ranging from 15 to 25 mm before folding, which corresponds to a significant dead volume, since the tabs are not generating current. This dead volume penalizes the volumetric capacity of the cell. We therefore seek to reduce the volume occupied by the tabs under the cover of the cell by reducing the height they occupy.

There is also a need to reduce the height of the tabs with the aim of, firstly, reducing the quantity of metal strip necessary for the manufacture of a plate and, secondly, reducing the quantity of strip scrap metal caused by cutting the tabs. In fact, the strip is cut to the desired dimensions starting from a long length of metal strip. The tabs are obtained by cutting the longitudinal edges of the strip. The portions of the strip located on either side of the tab constitute scrap metal that must be minimized. FIG. 6 schematically shows the strip width required for the manufacture of plates for a conventional tab height. FIG. 7 schematically shows the strip width necessary for the manufacture of plates for a reduced tab height. The width of the metal strips located on the left and right edges of the strip in FIG. 7 is less than that of the metal strips located on the left and right edges of the strip in FIG. 6.

U.S. Pat. No. 10,749,204 discloses a prismatic cell in which an electrical connection part connects the plates of one polarity to a current collecting terminal of corresponding polarity. The welding between the electrical connection part and the plates is carried out on a side surface, of the tab portion of the plates. However, the surface area of contact between the electrical connection part and each plate gets reduced because welding is carried out over a short distance which corresponds to the thickness of the edge of the plates. This can lead to a fragility of the connection for certain plates of the electrode plate group and to an overall high electrical resistance. There is consequently a need for an electrical connection part which makes it possible to obtain a solid connection and which does not increase the electrical resistance of the cell.

US Patent application 2013/0330631 discloses an electrochemical cell of prismatic format in which the tabs are first all welded to each other, then one of the tabs larger in size than the other tabs is connected to the cell cover. In this document, only one of the tabs is directly connected to the cover.

There is a need for an electrical connection part for an electrochemical cell of prismatic format which solves the problems mentioned above.

### SUMMARY OF THE INVENTION

The present invention provides an electrochemical cell comprising:
a) a container comprising a bottom and containing an assembly of parallelepipedal plates consisting of at least one positive plate and of at least one negative plate separated by a separator, said at least one positive plate comprising a positive tab consisting of a portion of a first current collector not covered with positive active material, said at least one negative plate comprising a negative tab consisting of a portion of a second current collector not covered with negative active material;
b) at least one cover closing an opening of the container;
c) an electrical connection part of a given polarity connecting at least one tab of the same polarity to a current output terminal of the cell of the same polarity, fixed to the cover;
an electrical connection part of opposite polarity connecting at least one tab of opposite polarity to a current output terminal of the cell of opposite polarity, the current output terminal of opposite polarity being fixed either to, and electrically insulated, from the cover, or to the bottom of the container, or to a second cover electrically insulated from the first cover;
the electrical connection part of given polarity and the electrical connection part of opposite polarity each comprising a support plate having one or more connection means, each connection means connecting a given polarity tab to the current output terminal of corresponding polarity.

According to one embodiment, the positive electrical connection part and the negative electrical connection part are fixed on a face of the at least one cover facing the inside of the cell, the negative electrical connection part being electrically insulated from the cover.

According to one embodiment, a weld bead connects a positive or negative tab to a connection means of the connection part of corresponding polarity, the weld bead extending in a direction parallel to the longitudinal plane of the plate.

According to one embodiment, each connection means is a projecting element formed on a face of the support plate oriented towards the inside of the cell.

According to one embodiment, the projecting element has the shape of a triangular prism, one of the faces of the prism serving as a connection surface for connecting one or more tabs to the connection part.

According to one embodiment, the plurality of connecting means forms a series of triangular prisms aligned parallel to one another.

According to one embodiment, the angle of an apex of the prism opposite to the side of the prism in contact with the support plate ranges from 10 to 45°, preferably from 25 to 35°.

According to one embodiment, the height of the projecting element ranges from 2 to 5 mm, preferably from 3 to 4 mm.

According to one embodiment, the height of the tab ranges from 3 to 10 mm, preferably from 4 to 7 mm, more preferably from 5 to 6 mm.

According to one embodiment, the electrochemical cell is of the lithium-ion type.

The invention also provides a method for manufacturing an

electrochemical cell comprising the steps of:
a) providing at least one cover;
b) fixing a first electrical connection part of a given polarity on one face of said at least one cover, said face being intended to be oriented towards the inside of the cell, and fixing a second connection part of opposite polarity either on the same face of the cover, with the second connection part being electrically insulated from the cover, or on a face of a second cover, said face being intended to be oriented towards the inside of the cell, the two electrical connection parts each comprising a support plate having one or more connection means;
c) providing a plate of given polarity, said plate comprising a tab consisting of a portion of a first current collector not covered with active material;
d) welding the tab of step c) to a connection means of the connecting part of corresponding polarity;
e) placing a separator on the plate obtained in step d);
f) providing a plate of opposite polarity to that of the plate of step c), said plate comprising a tab consisting of a portion of a second current collector not covered with active material;
g) welding the tab of step f) to a connection means of the connection part of corresponding polarity;
h) repeating steps c) to g) to obtain an electrochemical plate group.

In one embodiment, the method further comprises a step i) of inserting the electrochemical plate group connected to said at least one cover into a container of parallelepipedal format.

The invention also provides a method for manufacturing an

electrochemical cell comprising the steps of:
a) providing at least one cover and a parallelepiped format container, at least one of the walls of the container being constituted by the incorporation of said at least one cover;
b) fixing a first electrical connection part of a given polarity on a face of the cover, said face being intended to be oriented towards the inside of the cell and fixing a second electrical connection part of opposite polarity either on the same face of the cover, the second electrical connection part being electrically insulated from the cover, or on a wall of the container other than the cover, or on a face of a second cover, said face being intended to be oriented towards the inside of the cell, the two electrical connection parts each comprising a support plate having one or more connection means;
c) placing a plate of given polarity adjacent one of the two walls of larger surface of the container, said plate comprising a tab consisting of a portion of a first current collector not covered with active material;
d) welding the tab of step c) to a connection means of the connection part of corresponding polarity;
e) placing a separator on the plate obtained in step d);
f) placing on the separator a plate of opposite polarity to that of the plate of step c), said plate comprising a tab consisting of a portion of a second current collector not covered with active material,
g) welding the tab of step f) to a connection means of the connecting part of corresponding polarity;
h) repeating steps c) to g) to obtain an electrochemical plate group.

According to one embodiment of the two methods described above, welding of the tab of steps d) and g) is performed in a direction parallel to the longitudinal plane of the plate.

According to one embodiment, the welding of steps d) and g) is carried out using a laser, the beam of which makes an angle of 10 to 45° with respect to the longitudinal plane of the cover, preferably ranging from 25 to 35°.

Embodiments of the invention are described below in more detail with reference to the attached drawings.

### BRIEF DESCRIPTION OF THE DRAWINGS

FIG. 1 schematically shows an electrode plate group of parallelepiped format formed by the assembly of a rectangular positive plate, a separator and a negative rectangular plate.

FIG. 2 is a sectional view of two electrode plate groups arranged adjacent each other. The tabs of a given polarity protrude from the upper edge of the two electrode plate groups and are connected to a common L-shaped electrical connection part.

FIG. 3 is a perspective view of two electrode plate groups arranged adjacent each other. The positive and negative tabs protrude from the upper edge of the two electrode plate groups and are intended to be connected respectively to a common positive electrical connection part and to a common negative electrical connection part.

FIG. 4 is a perspective view of the upper part of the two electrode plate groups after welding the free end of the positive and negative electrical connection parts to the feet of the positive and negative current collecting terminals located under the cell cover.

FIG. 5 is a sectional view of the two electrode plate groups after welding the free end of one of the two positive or negative electrical connection parts at the foot of the current collecting terminal of the same polarity located under the cell cover.

FIG. 6 shows schematically the width of the metal strip necessary for the manufacture of plates and the scrap metal resulting from cutting of the tabs for a conventional tab height.

FIG. 7 schematically represents the width of metal strip necessary for the manufacture of plates and the scrap metal resulting from cutting of the tabs for a reduced tab height.

FIG. 8 is a perspective view of the electrical connection part according to the invention.

FIG. 9 is a longitudinal sectional view of the electrical connection part according to the invention.

FIG. 10 is a perspective view of a first positive plate and a first negative plate connected to their respective current collecting terminals at the start of the implementation of the first mode of carrying out the method according to the invention.

FIG. 11 is a perspective view of the positive and negative plates connected to their current collecting terminals respective at a more advanced stage of the connection than that illustrated in FIG. 10.

FIG. 12 shows a perspective view of the positive and negative plates connected to their respective current collecting terminals for a complete electrode plate group.

FIG. 13 is a detailed view of the electrical connection region between a tab and an electrical connection part.

FIG. 14 is a perspective view of a first positive plate and a first negative plate connected to their respective current collecting terminals at the start of the implementation of the second mode of carrying out the method according to the invention.

FIG. 15 is a perspective view of the positive and negative plates connected to their respective current collecting terminals for a complete electrode plate group manufactured according to the second mode of carrying out the method according to the invention.

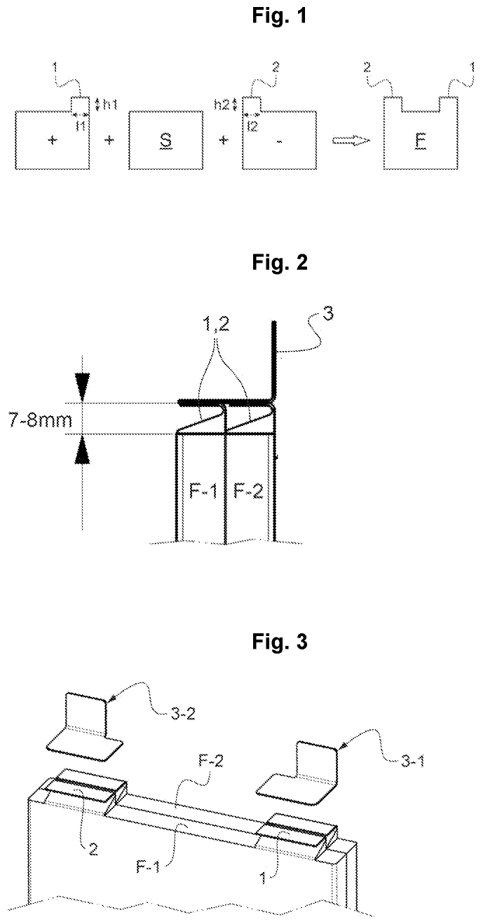

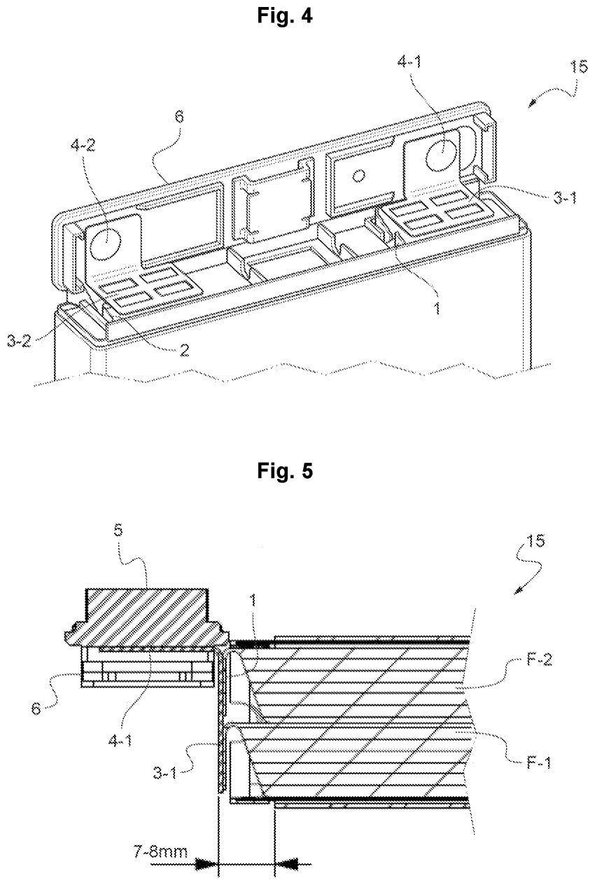

### DETAILED DESCRIPTION OF PREFERED EMBODIMENTS

### The Electrical Connection Part

The electrical connection part characterizes the electrochemical cell according to the invention. It includes a support which can be a plate or support plate. One of the faces of this plate is fixed, for example by welding, to the internal face of the cover. The opposite face of the plate is oriented towards the inside of the cell and includes said at least one projecting connection means.

The electrical connection part may include only one connection means in which case one or more tabs are connected to the single projecting connection means. This embodiment is nevertheless not preferred because the existence of a single connection means induces a restriction of current flow and an increase in the internal resistance of the cell, which is not desirable. Preferably therefore, the electrical connection part carries a plurality of projecting connection means, each connection means being connected to a tab of given polarity. Thus, each plate is electrically connected to the current collecting terminal of corresponding polarity via a projecting connection means. Preferably, there are as many connection means per support plate as there are plates of a given polarity in the cell. We can nevertheless anticipate connecting several plates of the same polarity to the same projecting connection means. The connection can be made by ultrasonic welding or laser welding. The laser welding technique is preferred because it is easier to implement than the ultrasonic method, the direction of the laser plate group can be easily modified and precisely adjusted.

The connection means is a projecting element which protrudes from the support plate. This projecting element extends in the direction of the width of the tab over a length generally at least equal to the width of the tab. The highest point of the projecting element may be located at a height ranging from 2 to 5 mm, preferably 3 to 4 mm relative to the base of the projecting element, that is to say relative to the surface of the support plate. The distance between two projecting elements preferably corresponds to the spacing between two plates of the same polarity. The various projecting elements are aligned parallel to each other on the surface of the support plate.

The cross section of the projecting element can be rectangular, trapezoidal, triangular or semi-circular. Preferably, the cross section is triangular. The projecting element extends in the direction of the width of the tab and therefore forms a triangular prism, one of the faces of the prism serving as a connection surface for connecting a tab to the electrical connection part. The angle of the top of the prism opposite the side of the prism in contact with the support plate generally ranges from 10 to 45°,preferably from 25 to 35°.

As the weld bead connecting the tab to the projecting element extends in a direction parallel to the longitudinal plane of the tab, it is possible to obtain a weld offering good mechanical strength, unlike the connection described in U.S. Pat. No. 10,749,204 in which welding is carried out on the edge of the tabs.

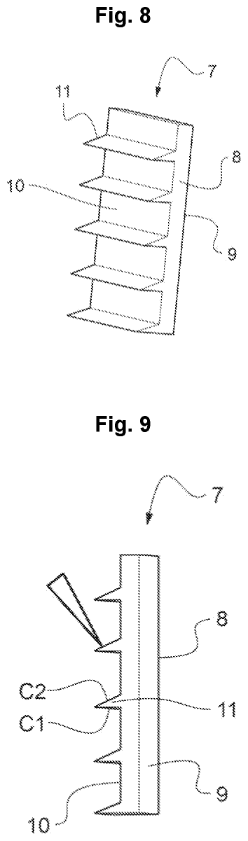

FIG. 8 shows a perspective view of an example of an electrical connection part 7 according to the invention, in which the projecting element is a triangular prism. FIG. 9 shows a sectional view of this same electrical connection part. The electrical connection part includes a support plate 8 having a rectangular shape. A first face 9 of the support plate is intended to be connected, for example by welding, to the internal face of the cover of the cell, not shown. The opposite face 10 of the support plate includes five projecting connection means in the form of triangular prisms 11. These prisms extend in the direction of the width of the support plate. They are distributed at regular intervals along the length of the support plate. Their cross section is triangular. A first side C1 of the triangle is perpendicular to the support plate. A second side C2 forms an angle of 10 to 45° relative to the first side C1. It is on the side, C2, that the connection to the tab is made. The arrow shows the direction of the laser plate group during the tab welding stage. The angle of the laser plate group can range from 10 to 45° relative to the vertical direction, preferably 25 to 35°.

The metal of the electrical connection part can be chosen from copper or copper alloys, aluminum or aluminum alloys, nickel or nickel alloys, steel and stainless steel. In the case of an electrochemical cell of the lithium-ion type, the positive electrical connection part connecting said at least one positive plate to the positive current collecting terminal is preferably made of aluminum or an aluminum-based alloy. The negative electrical connection part connecting said at least one negative plate to the negative current collecting terminal is preferably made of copper or a copper-based alloy.

The invention makes it possible to reduce the height of the tabs. While until now, the tabs generally had a height ranging from 15 to 25 mm, the invention makes it possible to reduce this height to a value ranging from 3 to 10 mm, preferably from 4 to 7 mm, more preferably 5 to 6 mm. Of these 5 to 6 mm, approximately 3 mm are used for welding on the projecting connection means. Approximately 2 mm are left free, thus giving the plate a certain flexibility in relation to its point of connection on the electrical connection part.

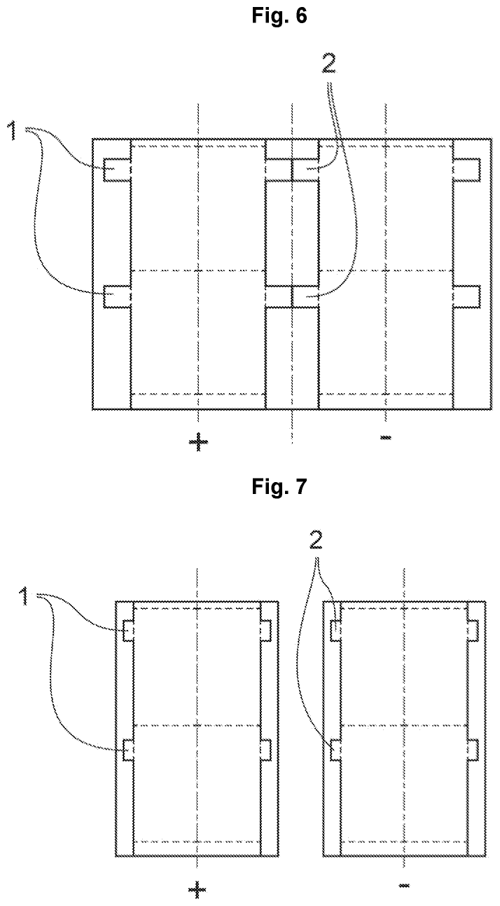

The invention makes it possible to reduce the distance between an edge of the electrode plate group and the cover of the cell, thereby increasing the volumetric capacity of the cell. It also makes it possible to reduce the quantity of scrap copper and aluminum which inevitably occurs during the cutting operation of the tabs, as highlighted by a comparison of FIG. 7 with FIG. 6.

### Method of Electrically Connecting the Positive and Negative Plates to the Current Collecting Terminals of the Cell

The method of electrical connection of the positive and negative plates to the current collecting terminals of the cell will now be described according to a first embodiment.

In a first step a), at least one rectangular cover is provided. This cover has a first surface intended to be oriented towards the outside of the cell. This first surface carries one or two current collecting terminals of the cell. The cover has a second surface intended to be oriented towards the interior of the cell. This second surface provides access to the foot of the current collecting terminal or to the feet of the two current collecting terminals. In the case of two current collecting terminals located on the same cover, these pass through the wall of the cover, one of them is electrically insulated from the cover by the use of a polymeric seal around this terminal.

In a second step b), a first electrical connection part of a given polarity, as described above, is fixed, for example by welding, on the face of the cover intended to be oriented towards the inside the cell. A second electrical connection part of opposite polarity is fixed either on the same face of the cover, this second electrical connection part being electrically insulated from the cover, or is fixed on one face of a second cover, this face also being intended to be oriented towards the inside of the cell. In the first case, the cover carries the two current collecting terminals. In the case of a lithium-ion electrochemical cell, the first electrical connection part is the positive electrical connection part, generally made of aluminum. It is welded to the cover which is also generally made of aluminum. The second electrical connection part is the negative electrical connection part electrically insulated from the first cover by a plastic seal. In the second case, the current collecting terminals are located on two different walls of the cell, for example opposite walls. This second cover closes a second opening of the container. This second case requires the use of covers of various sizes to allow the introduction of the electrode plate group into the container.

In a third step c), a plate of given polarity is provided, said plate comprising a tab consisting of a portion of a first current collector not covered with active material.

In a fourth step d), the tab of step c) is welded to a projecting connection means of the electrical connection part of corresponding polarity.

In a fifth step e), a separator is placed on the plate obtained in step d).

In a sixth step f), a plate of polarity opposite to that of the plate of step c) is provided, said plate comprising a tab consisting of a portion of a second current collector not covered with active material.

In a seventh step g), the tab of step f) is welded to a projecting connection means of the electrical connection part of corresponding polarity.

Steps c) to g) are repeated to obtain an electrode plate group connected to at least one cover.

The method according to the invention is characterized by a step-by-step connection of the tabs to the electrical connection part, that is to say one plate after the other, unlike the methods of the prior art in which all the tabs are welded at once and the same time to the electrical connection part. According to the invention, the connection of a tab to a projecting connection means is only carried out if the connection of the underlying tab has previously been carried out. The equipment dedicated to stacking the plates can be associated with equipment dedicated to carrying out welding on the tabs.

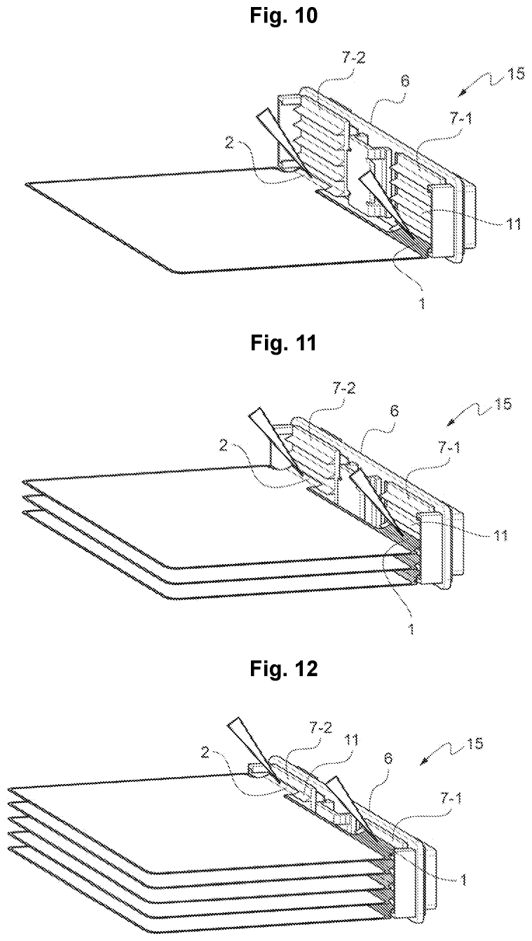

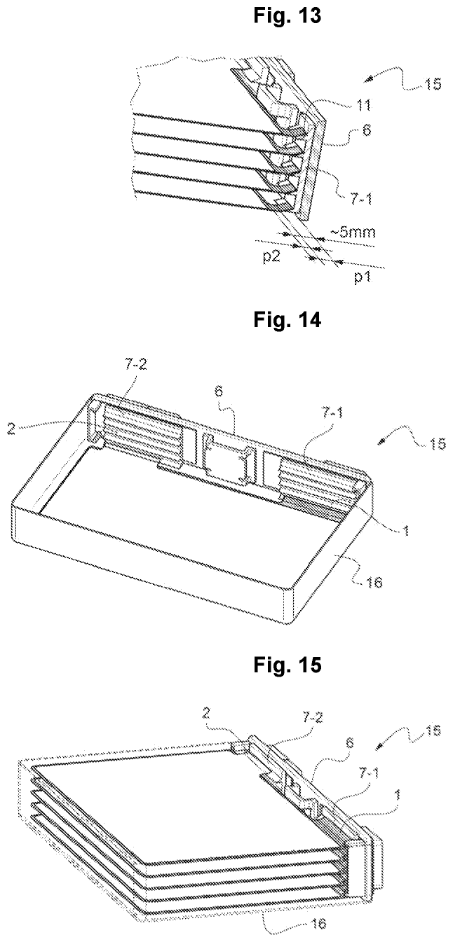

FIGS. 10 to 12 are a perspective view of the positive and negative plates at various times of the manufacturing of the electrode plate group in the particular case of a location of the two current collecting terminals on the same cover, but it should be understood that the invention also includes the case of two current collecting terminals located on two covers arranged on two opposite faces of the cell. In FIG. 10, we can see a first positive plate having a positive tab 1 connected to a projecting element 11 of triangular cross section of a positive electrical connection part 7-1 and a first negative plate having a negative tab 2 connected to a projecting element of triangular cross section of a negative electrical connection part 7-2. The positive and negative electrical connection parts are fixed on the inner surface of the cover 6. FIG. 11 shows the electrode plate group at a more advanced state of connecting the plates to the cover. Three positive plates and three negative plates were connected to the cover. FIG. 12 shows the electrochemical plate group after connection of all the projecting connection means of the positive electrical connection part to a positive plate and all the projecting connection means of the negative electrical connection part to a negative plate. FIG. 13 is a detailed view of the electrical connection region

between a tab and a projecting connection means. It shows that a first part p1 of the tab is welded to one of the surfaces of the projecting connection means. This first part can be as short as 3 mm. A second part p2 of the tab is “free”, that is to say not welded to the projecting connection means. It can measure around 2 mm.

The manufacture of the electrochemical cell can continue with the following steps: The electrode plate group provided with its cover(s) is introduced into a container of parallelepiped format. The cell container is filled with an electrolyte. Then, the cover(s) on the container are hermetically closed to obtain the cell 15. The container is rigid (not deformable by hand) and is generally made of metal, such as aluminum. It can also be made of a rigid plastic material. Before introducing the electrode plate group into the container, the side faces of the electrode plate group can be surrounded by an electrically insulating polymeric film so as to electrically insulate it from the container.

The method of electrical connection of the positive and negative plates to the current collecting terminals of the cell will now be described in a second embodiment. This second embodiment differs from the first in that the installation of the positive and negative plates is carried out directly in the container of the cell. The step of introducing the electrode plate group into the container of the cell, once the fabrication of the electrode plate group is completed, which is described in the first embodiment, no longer takes place. In this second embodiment, three sub-embodiments are possible.

In a first sub-embodiment, a cover constitutes one of the walls of the container. It is embedded in the ends of two facing walls of the container. The manufactured cell then includes only one cover supporting the two current collecting terminals. In this case, the single cover is equipped with positive and negative electrical connection parts.

In a second sub-embodiment, the manufactured cell comprises two covers, each cover supporting a current collecting terminal. In this case, each cover is equipped with a single electrical connection part, positive or negative. The two covers can be placed on two opposite walls of the cell. They are embedded in the ends of two walls generally facing each other.

In a third sub-embodiment, the manufactured cell comprises a single cover supporting a first current collecting terminal. The cover is embedded in the ends of two facing walls of the container. A wall of the container, generally the one opposite the cover, carries a second current collecting terminal. An electrical connection part is directly welded to this wall of the container.

The walls of the container and the wall formed by the cover (or the walls formed by the two covers) define a volume in which the stacking and connection of the positive and negative plates is carried out. The plates are assembled by introducing the plates into this volume and welding the plates, one by one, to the electrical connection parts. The wall of the container with the largest surface area serves as a support surface for stacking the plates. As in the first embodiment, the connection of the positive and negative tabs is carried out progressively, that is to say one plate after the other. The cell is closed not by closing the cover(s), which is or are already fixed to the container, but rather by welding a wall of the container of the cell, generally the wall opposite to the surface serving as a support surface for stacking the plates.

FIGS. 14 and 15 show an electrochemical cell at various times of its manufacture according to this second embodiment, in the particular case where the two current collecting terminals are located on the same cover, in other words the first sub-embodiment. In FIG. 14, we can see a container 16 having three side walls and a fourth side wall formed by a cover 6. The cover is embedded between the ends of two facing walls of the container. A first positive plate having a positive tab 1 is connected to a projecting element of triangular cross section of a positive electrical connection part 7-1 and a first negative plate having a negative tab 2 is connected to a projecting element of triangular cross section of a negative electrical connection part 7-2. The first positive plate and the first negative plate are supported on one of the two largest surface walls of the container. Super-positioning of a positive plate, a separator and a negative plate continues until the stack obtained almost reaches the upper edge of the side walls of the container. Such a situation is shown in FIG. 15. Finally, a wall is placed in contact with the upper edges of the side walls of the container and the edge of the cover. It hermetically seals the electrochemical cell.

In the implementation of the method according to the invention, whether in the first or the second embodiment, the welding of the tab of steps d) and g) is carried out in one direction parallel to the longitudinal plane of the tab (or of the plate), therefore in the direction of the width of the tab. The welding of steps d) and g) is preferably carried out using a laser the beam of which makes an angle of 10 to 45° relative to the longitudinal plane of the cover, preferably ranging from 25 to 35°.

1. An electrochemical cell comprising:
a) a container comprising a bottom and containing an assembly of parallelepipedal plates consisting of at least one positive plate and of at least one negative plate separated by a separator, said at least one positive plate comprising a positive tab consisting of a portion of a first current collector not covered with positive active material, said at least one negative plate comprising a negative tab consisting of a portion of a second current collector not covered with negative active material;
b) at least one cover closing an opening of the container;
c) an electrical connection part of a given polarity connecting at least one tab of the same polarity to a current output terminal of the cell of the same polarity, fixed to a cover;
an electrical connection part of opposite polarity connecting at least one tab of opposite polarity to a current output terminal of the cell of opposite polarity, the current output terminal of opposite polarity being fixed either to, and electrically insulated from, the cover, or to the bottom of the container, or to a second cover electrically insulated from the first cover;
the electrical connection part of given polarity and the electrical connection part of opposite polarity each comprising a support plate having one or more connection means, each connection means connecting a given polarity tab to the current output terminal of corresponding polarity.

2. The electrochemical cell according to claim 1, wherein the positive electrical connection part and the negative electrical connection part are fixed on a face of the at least one cover facing the inside of the cell, the negative electrical connection part being electrically insulated from the cover.

3. The electrochemical cell according to claim 1, wherein a weld bead connects a positive or negative tab to a connection means of the connection part of corresponding polarity, the weld bead extending in a direction parallel to the longitudinal plane of the plate.

4. The electrochemical cell according to claim 1, wherein each connection means is a projecting element formed on a face of the support plate oriented towards the inside of the cell.

5. The electrochemical cell according to claim 4, wherein the projecting element has the shape of a triangular prism, one of the faces of the prism serving as a connection surface for connecting one or more tabs to the connection part.

6. The electrochemical cell according to claim 1, wherein the plurality of connecting means forms a series of triangular prisms aligned parallel to one another.

7. The electrochemical cell according to claim 5, in which the an angle of an apex of the prism opposite to the side of the prism in contact with the support plate ranges from 10 to 45°, preferably from 25 to 35°.

8. The electrochemical cell according to claim 4, wherein a height of the projecting element ranges from 2 to 5 mm, preferably from 3 to 4 mm.

9. The electrochemical cell according to claim 1, wherein a height of the tab ranges from 3 to 10 mm, preferably from 4 to 7 mm, more preferably from 5 to 6 mm.

10. The electrochemical cell according to claim 1, of the lithium-ion type.

11. A method of manufacturing an electrochemical cell comprising the steps of:
a) providing at least one cover;
b) fixing a first electrical connection part of a given polarity on one face of said at least one cover, said face being intended to be oriented towards the inside of the cell, and fixing a second connection part of opposite polarity either on the a same face of the cover, with the second connection part being electrically insulated from the cover, or on a face of a second cover, said face being intended to be oriented towards the inside of the cell, the two electrical connection parts each comprising a support plate having one or more connection means;
c) providing a plate of given polarity, said plate comprising a tab consisting of a portion of a first current collector not covered with active material;
d) welding the tab of step c) to a connection means of the connecting part of corresponding polarity;
e) placing a separator on the plate obtained in step d);
f) providing a plate of opposite polarity to that of the plate of step c), said plate comprising a tab consisting of a portion of a second current collector not covered with active material;
g) welding the tab of step f) to a connection means of the connection part of corresponding polarity;
h) repeating steps c) to g) to obtain an electrochemical plate group.

12. The method according to claim 11, further comprising the step i) of inserting the electrochemical plate group connected to said at least one cover into a container of parallelepipedal format.

13. A method of manufacturing an electrochemical cell comprising the steps of:
a) providing at least one cover and a parallelepiped format container, at least one of the walls of the container being constituted by the incorporation of said at least one cover;
b) fixing a first electrical connection part of a given polarity on a face of the cover, said face being intended to be oriented towards the inside of the cell and fixing a second electrical connection part of opposite polarity either on the same face of the cover, the second electrical connection part being electrically insulated from the cover, or on a wall of the container other than the cover, or on a face of a second cover, said face being intended to be oriented towards the inside of the cell, the two electrical connection parts each including a support plate having one or more connection means;
c) placing a plate of given polarity adjacent one of the two walls of larger surface of the container, said plate comprising a tab consisting of a portion of a first current collector not covered with active material;
d) welding the tab of step c) to a connection means of the connection part of corresponding polarity;
e) placing a separator on the plate obtained in step d);
f) placing on the separator a plate of opposite polarity to that of the plate of step c), said plate comprising a tab consisting of a portion of a second current collector not covered with active material,
g) welding the tab of step f) to a connection means of the connecting part of corresponding polarity;
h) repeating steps c) to g) to obtain an electrochemical plate group.

14. The method according to claim 11, wherein the welding of the tab of steps d) and g) is performed in a direction parallel to the longitudinal plane of the plate.

15. The method according to claim 11, in which the welding of steps d) and g) is carried out using a laser, the beam of which forms an angle of 10 to 45° with respect to the a longitudinal plane of the cover, preferably ranging from 25 to 35°.

16. The method according to claim 12, in which the welding of steps d) and g) is carried out using a laser, the beam of which forms an angle of 10 to 45° with respect to a longitudinal plane of the cover, preferably ranging from 25 to 35°.

17. The method according to claim 13, in which the welding of steps d) and g) is carried out using a laser, the beam of which forms an angle of 10 to 45° with respect to a longitudinal plane of the cover, preferably ranging from 25to 35°.

18. The method according to claim 12, wherein the welding of the tab of steps d) and g) is performed in a direction parallel to the longitudinal plane of the plate.

19. The method according to claim 13, wherein the welding of the tab of steps d) and g) is performed in a direction parallel to the longitudinal plane of the plate.

20. The electrochemical cell according to claim 6, in which an angle of an apex of the prism opposite to the side of the prism in contact with the support plate ranges from 10 to 45°,preferably from 25 to 35.
